(19) United States
(12) Patent Application Publication
(10) Pub. No.: US 2024/0289729 A1
(43) Pub. Date: Aug. 29, 2024

(54) Aerial Delivery Tracking SDK

(71) Applicant: Wing Aviation LLC, Palo Alto, CA (US)

(72) Inventors: Joseph Robert Owen, Gaithersburg, MD (US); Simon Alexander Carroll, San Jose, CA (US); Jing Yi Tang, Somerville, MA (US); Kevin Yifu He, Kirkland, WA (US); Jeremy Ozymandias Aery Fallick, Palo Alto, CA (US)

(21) Appl. No.: 18/399,409

(22) Filed: Dec. 28, 2023

Related U.S. Application Data
(60) Provisional application No. 63/477,893, filed on Dec. 30, 2022.

(51) Int. Cl. G06Q 10/0833

(52) U.S. Cl. CPC G06Q 10/0833

(57) ABSTRACT

A method includes receiving, at a user device, a user selection entered into a third-party application to have a payload delivered to a delivery location via an uncrewed aerial vehicle (UAV). The method also includes displaying, by the user device within the third-party application, a first UI portion of a delivery software development kit (SDK). The first UI portion enables user selection of a delivery point at the delivery location. The method additionally includes after user selection of the delivery point, receiving, at the user device, a delivery status update from the delivery SDK indicating that the UAV has commenced delivery of the payload. The method also includes displaying, by the user device within the third-party application, a second UI portion of the delivery SDK. The second UI portion displays UAV tracking information as the UAV delivers the payload to the selected delivery point at the delivery location.

### CROSS-REFERENCE TO RELATED APPLICATIONS

This application claims the benefit of priority of U.S. Provisional Application No. 63/477,893 filed Dec. 30, 2022, which is hereby incorporated herein by reference in its entirety.

### BACKGROUND

An uncrewed vehicle, which may also be referred to as an autonomous vehicle, is a vehicle capable of travel without a physically-present human operator. An uncrewed vehicle may operate in a remote-control mode, in an autonomous mode, or in a partially autonomous mode.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter UAVs, among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

Examples disclosed herein include methods for facilitating UAV delivery of an item by way of a software development kit (SDK) within a third-party application on a user device. The SDK, via the user device, may communicate with remote servers to send and receive data relating to the UAV delivery of the item. The SDK may also display a plurality of user interface (UI) portions within the third-party application at various stages throughout the UAV delivery process for the user to interact with.

In a first aspect, a method includes receiving, at a user device, a user selection entered into a third-party application to have a payload delivered to a delivery location via an unmanned aerial vehicle (UAV). The method also includes displaying, by the user device within the third-party application, a first UI portion of a delivery software development kit (SDK). The first UI portion enables user selection of a delivery point at the delivery location. The method further includes after user selection of the delivery point, receiving, at the user device, a delivery status update from the delivery SDK indicating that the UAV has commenced delivery of the payload. The method additionally includes displaying, by the user device within the third-party application, a second UI portion of the delivery SDK. The second UI portion displays UAV tracking information as the UAV delivers the payload to the selected delivery point at the delivery location.

In a second aspect, a user device comprises one or more processors and a non-transitory computer readable medium that comprises program instructions executable by the one or more processors to perform operations comprising receiving a user selection entered into a third-party application to have a payload delivered to a delivery location via an unmanned aerial vehicle (UAV). The operations further comprise displaying, within the third-party application, a first UI portion of a delivery software development kit (SDK). The first UI portion enables user selection of a delivery point at the delivery location. The operations additionally comprise after user selection of the delivery point, receiving a delivery status update from the delivery SDK indicating that the UAV has commenced delivery of the payload. The operations also comprise displaying, within the third-party application, a second UI portion of the delivery SDK. The second UI portion displays UAV tracking information as the UAV delivers the payload to the selected delivery point at the delivery location.

In a third aspect, a non-transitory computer readable medium comprises program instructions executable by one or more processors to perform operations comprising receiving, at a user device, a user selection entered into a third-party application to have a payload delivered to a delivery location via an unmanned aerial vehicle (UAV). The operations further comprise displaying, by the user device within the third-party application, a first UI portion of a delivery software development kit (SDK). The first UI portion enables user selection of a delivery point at the delivery location. The operations additionally comprise after user selection of the delivery point, receiving, at the user device, a delivery status update from the delivery SDK indicating that the UAV has commenced delivery of the payload. The operations also comprise displaying, by the user device within the third-party application, a second UI portion of the delivery SDK. The second UI portion displays UAV tracking information as the UAV delivers the payload to the selected delivery point at the delivery location.

In a further aspect, a system includes means for receiving, at a user device, a user selection entered into a third-party application to have a payload delivered to a delivery location via an unmanned aerial vehicle (UAV). The system further includes means for displaying, by the user device within the third-party application, a first UI portion of a delivery software development kit (SDK). The first UI portion enables user selection of a delivery point at the delivery location. The system also includes means for after user selection of the delivery point, receiving, at the user device, a delivery status update from the delivery SDK indicating that the UAV has commenced delivery of the payload. The system additionally includes means for displaying, by the user device within the third-party application, a second UI portion of the delivery SDK. The second UI portion displays UAV tracking information as the UAV delivers the payload to the selected delivery point at the delivery location

These, as well as other aspects, advantages, and alternatives, will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an uncrewed aerial vehicle, according to example embodiments, in accordance with example embodiments.

FIG. 1B is a simplified illustration of an uncrewed aerial vehicle, according to example embodiments, in accordance with example embodiments.

FIG. 1C is a simplified illustration of an uncrewed aerial vehicle, according to example embodiments, in accordance with example embodiments.

FIG. 1D is a simplified illustration of an uncrewed aerial vehicle, according to example embodiments, in accordance with example embodiments.

FIG. 1E is a simplified illustration of an uncrewed aerial vehicle, according to example embodiments, in accordance with example embodiments.

FIG. 2 is a simplified block diagram illustrating components of an uncrewed aerial vehicle, in accordance with example embodiments.

FIG. 3 is a simplified block diagram illustrating a UAV system, in accordance with example embodiments.

FIG. 4 is a simplified block diagram illustrating a UAV delivery communication system, in accordance with example embodiments.

FIG. 5 is a simplified block diagram illustrating components of a user device, in accordance with example embodiments.

FIG. 6 is an illustrative screen of an SDK interface within a third-party application displayed on a user device, in accordance with example embodiments.

FIGS. 7A-7C are illustrative screens of a first UI portion of an SDK interface within a third-party application displayed on a user device, in accordance with example embodiments.

FIGS. 8A-8D are illustrative screens of a second UI portion of an SDK interface within a third-party application displayed on a user device, in accordance with example embodiments.

FIG. 9 is a simplified block diagram of a method, in accordance with example embodiments.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### I. Overview

An example usage of UAVs may be to deliver various items to customers. For example, a UAV may be tasked with picking up a payload, from a third-party partner, containing an item from a location and delivering the payload to a customer's residence, commercial building, or other location. Usage of third-party applications to order items for delivery has become increasingly popular by customers. Many companies recognize the value of having an application for user devices, such as mobile phones, that allow customers to place an order for an item and deliver the item to a location selected by the customer. Companies devote considerable time and resources to developing and updating user device applications. One potential problem that might arise in developing and updating user device applications is the high engineering cost associated with integrating UAV delivery options into these applications. The company might not have the resources available to organically develop a UAV platform. The company might also lack the technical expertise necessary to consider all the elements and technical features that go into UAV delivery.

Moreover, third-party developed UAV delivery application functions would be limited on a platform-by-platform basis. Put another way, the UAV delivery software developed for use within a specific third-party application would be limited to that respective application and not facilitate cross-platform operability. Each third-party UAV delivery software might handle delivery differently than another, and/or require a user to create multiple accounts in order to request UAV delivery from different third-party providers. This may frustrate the user and lead to decreased use of UAV delivery.

Therefore, it may be beneficial to have a software development kit (SDK) that provides a native integration solution to third-party providers looking to add UAV delivery options to their user applications. An SDK is an installable package that includes a collection of software development tools that enable developers to build applications in a faster and more standardized manner. The use of SDKs may be beneficial in situations where a specific functionality is desired that lies outside of the specific expertise of the application designer. For example, the SDK may include a software framework, user interface portions, application programming interfaces (APIs), and/or other features for handling the logistics of UAV delivery which may be integrated into the third-party application by third-parties wishing to provide UAV delivery capabilities to users.

The SDK may allow for data relating to UAV delivery to be shared across the various third-party applications, standardizing user experience with UAV delivery. The SDK may leverage the data, such as previous delivery locations, of the user in one third-party application to use in another third-party application. Another advantage of providing an SDK for integration within a third-party application is leveraging route information or map data generated for an area. While a third-party is limited in geographic scope or existing clientele, a UAV delivery server might store data generated from all UAV deliveries across a broader geographic scope and clientele and apply the data when UAV delivery is requested for any respective third-party.

Another problem is third-party applications requiring users to exit the application to handle UAV delivery details, such as entering delivery location and tracking the item. This may occur when the third-party application does not include UAV delivery features and the UAV delivery is fulfilled by a separate provider. The user has to exit the application, and navigate to the provider application or website for UAV delivery.

Therefore it may be beneficial to provide UAV delivery functionality within a third-party application to centralize UAV delivery information for an item from a third-party and to avoid requiring the user to navigate to another application or website. The SDK may provide UAV information via an interface within the third-party application displayed on the user device. The SDK interface may allow the user to stay within the third-party application to handle aspects of UAV delivery. Providing a UAV delivery interface within a third-party application might allow the user to view both UAV delivery information and item information without navigating to multiple websites or applications. This might streamline the UAV delivery process for the user and create a more optimized user experience.

### II. Example Uncrewed Vehicles

Herein, the terms “uncrewed aerial vehicle” and “UAV” refer to any autonomous or semi-autonomous vehicle that is capable of performing some functions without a physically present human pilot. As would be understood by one of skill in the art, uncrewed and unmanned may be used interchangeably.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial system” (UAS) may also be used to refer to a UAV.

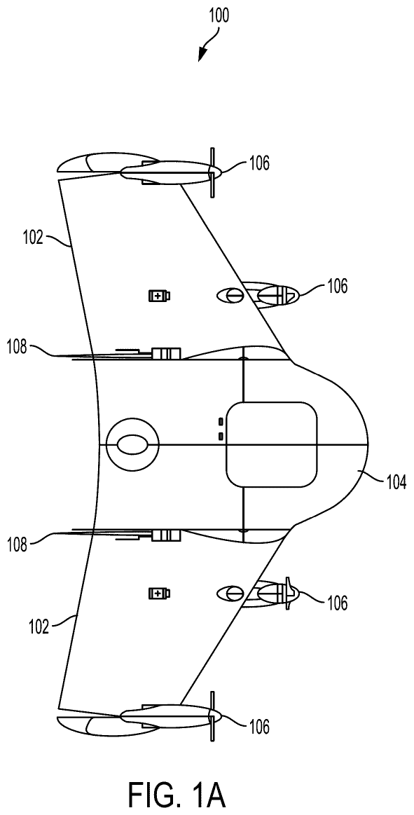

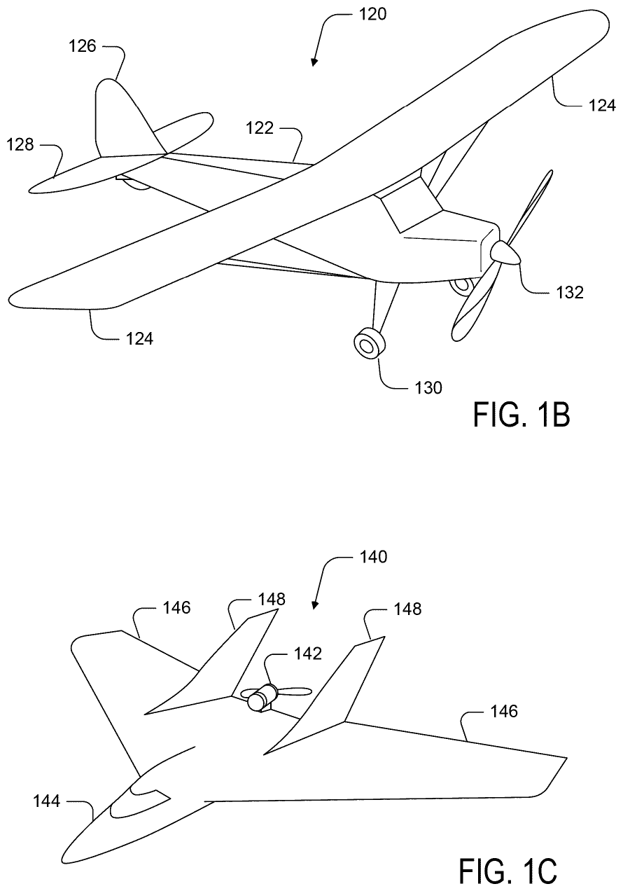

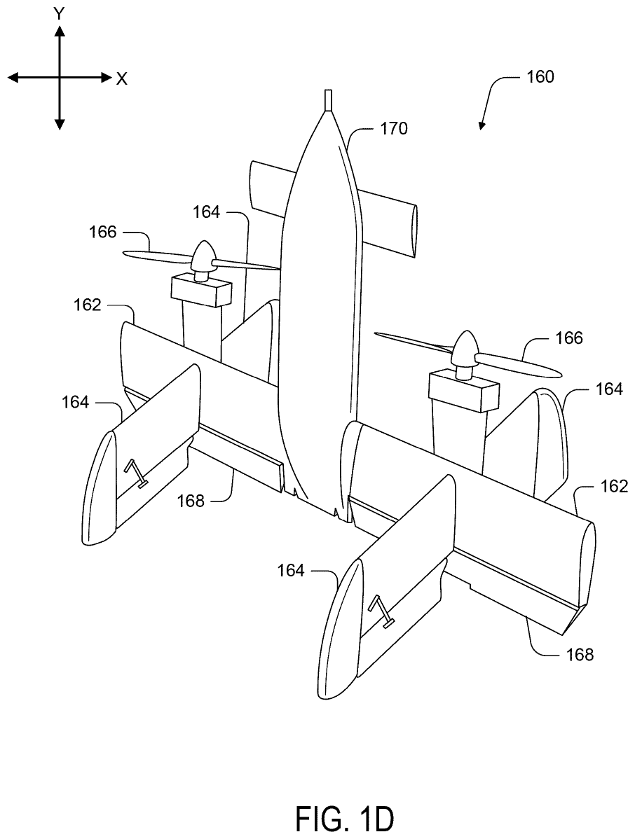

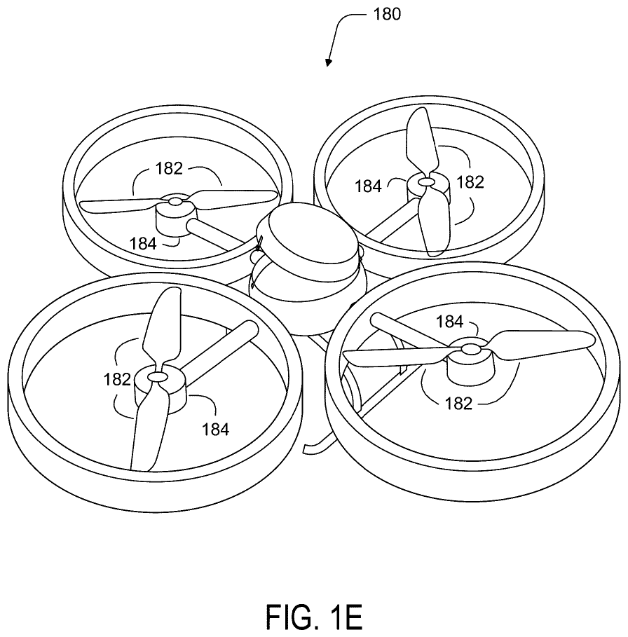

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1B, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “unamnned” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Illustrative UAV Components

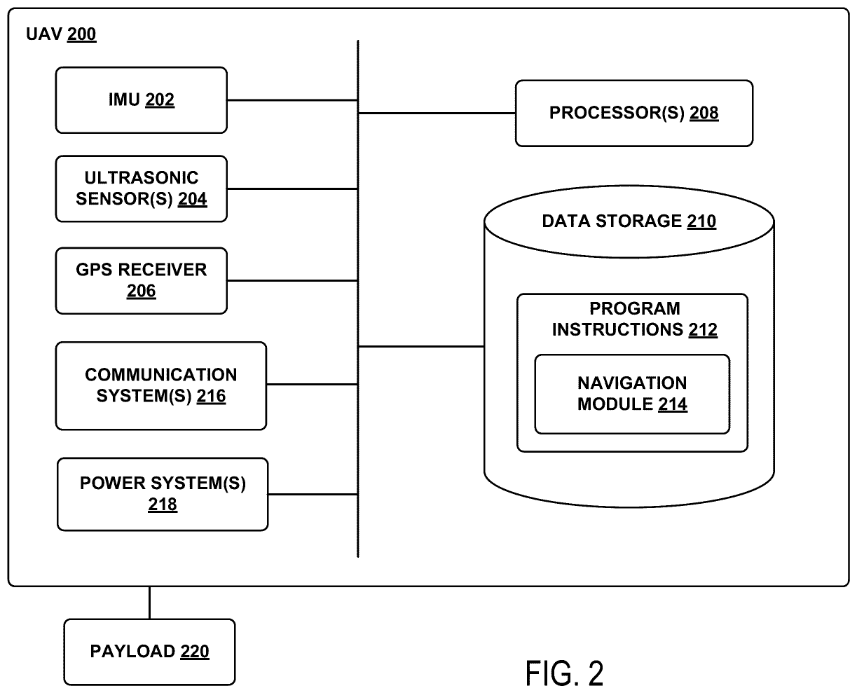

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

i. A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

i. B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location, the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals—in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I'm over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine latitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

i. C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

i. D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

i. E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may include one or more food items, purchased goods, medical items, or any other object(s) having a size and weight suitable to be transported between two locations by the UAV. In other embodiments, a payload 228 may simply be the one or more items that are being delivered (e.g., without any package housing the items).

In some embodiments, the payload 228 may be attached to the UAV and located substantially outside of the UAV during some or all of a flight by the UAV. For example, the package may be tethered or otherwise releasably attached below the UAV during flight to a target location. In some embodiments, the package may include various features that protect its contents from the environment, reduce aerodynamic drag on the system, and prevent the contents of the package from shifting during UAV flight. In other embodiments, the package may be a standard shipping package that is not specifically tailored for UAV flight.

In order to deliver the payload, the UAV may include a winch system 221 controlled by the tether control module 216 in order to lower the payload 228 to the ground while the UAV hovers above. As shown in FIG. 2, the winch system 221 may include a tether 224, and the tether 224 may be coupled to the payload 228 by a payload retriever 226. The tether 224 may be wound on a spool that is coupled to a motor 222 of the UAV. The motor 222 may take the form of a DC motor (e.g., a servo motor) that can be actively controlled by a speed controller. The tether control module 216 can control the speed controller to cause the motor 222 to rotate the spool, thereby unwinding or retracting the tether 224 and lowering or raising the payload retriever 226. In practice, the speed controller may output a desired operating rate (e.g., a desired RPM) for the spool, which may correspond to the speed at which the tether 224 and payload 228 should be lowered towards the ground. The motor 222 may then rotate the spool so that it maintains the desired operating rate.

In order to control the motor 222 via the speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor 222 causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

Based on the data from the speed sensor, the tether control module 216 may determine a rotational speed of the motor 222 and/or the spool and responsively control the motor 222 (e.g., by increasing or decreasing an electrical current supplied to the motor 222) to cause the rotational speed of the motor 222 to match a desired speed. When adjusting the motor current, the magnitude of the current adjustment may be based on a proportional-integral-derivative (PID) calculation using the determined and desired speeds of the motor 222. For instance, the magnitude of the current adjustment may be based on a present difference, a past difference (based on accumulated error over time), and a future difference (based on current rates of change) between the determined and desired speeds of the spool.

In some embodiments, the tether control module 216 may vary the rate at which the tether 224 and payload 228 are lowered to the ground. For example, the speed controller may change the desired operating rate according to a variable deployment-rate profile and/or in response to other factors in order to change the rate at which the payload 228 descends toward the ground. To do so, the tether control module 216 may adjust an amount of braking or an amount of friction that is applied to the tether 224. For example, to vary the tether deployment rate, the UAV 200 may include friction pads that can apply a variable amount of pressure to the tether 224. As another example, the UAV 200 can include a motorized braking system that varies the rate at which the spool lets out the tether 224. Such a braking system may take the form of an electromechanical system in which the motor 222 operates to slow the rate at which the spool lets out the tether 224. Further, the motor 222 may vary the amount by which it adjusts the speed (e.g., the RPM) of the spool, and thus may vary the deployment rate of the tether 224. Other examples are also possible.

In some embodiments, the tether control module 216 may be configured to limit the motor current supplied to the motor 222 to a maximum value. With such a limit placed on the motor current, there may be situations where the motor 222 cannot operate at the desired operation specified by the speed controller. For instance, as discussed in more detail below, there may be situations where the speed controller specifies a desired operating rate at which the motor 222 should retract the tether 224 toward the UAV 200, but the motor current may be limited such that a large enough downward force on the tether 224 would counteract the retracting force of the motor 222 and cause the tether 224 to unwind instead. And as further discussed below, a limit on the motor current may be imposed and/or altered depending on an operational state of the UAV 200.

In some embodiments, the tether control module 216 may be configured to determine a status of the tether 224 and/or the payload 228 based on the amount of current supplied to the motor 222. For instance, if a downward force is applied to the tether 224 (e.g., if the payload 228 is attached to the tether 224 or if the tether 224 gets snagged on an object when retracting toward the UAV 200), the tether control module 216 may need to increase the motor current in order to cause the determined rotational speed of the motor 222 and/or spool to match the desired speed. Similarly, when the downward force is removed from the tether 224 (e.g., upon delivery of the payload 228 or removal of a tether snag), the tether control module 216 may need to decrease the motor current in order to cause the determined rotational speed of the motor 222 and/or spool to match the desired speed. As such, the tether control module 216 may be configured to monitor the current supplied to the motor 222. For instance, the tether control module 216 could determine the motor current based on sensor data received from a current sensor of the motor or a current sensor of the power system 220. In any case, based on the current supplied to the motor 222, determine if the payload 228 is attached to the tether 224, if someone or something is pulling on the tether 224, and/or if the payload retriever 226 is pressing against the UAV 200 after retracting the tether 224. Other examples are possible as well.

During delivery of the payload 228, the payload retriever 226 can be configured to secure the payload 228 while being lowered from the UAV by the tether 224, and can be further configured to release the payload 228 upon reaching ground level. The payload retriever 226 can then be retracted to the UAV by reeling in the tether 224 using the motor 222.

In some implementations, the payload 228 may be passively released once it is lowered to the ground. For example, a passive release mechanism may include one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

### IV. Illustrative UAV Deployment Systems

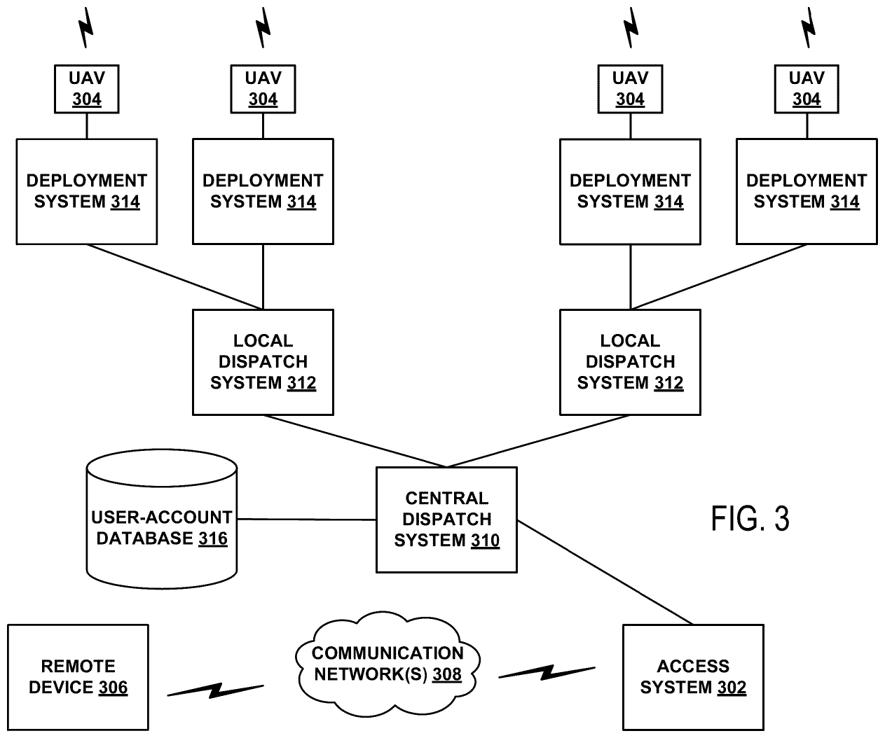

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UAVs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UAVs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch system 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on and alternatives to the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. Illustrative Delivery SDK Systems and Methods

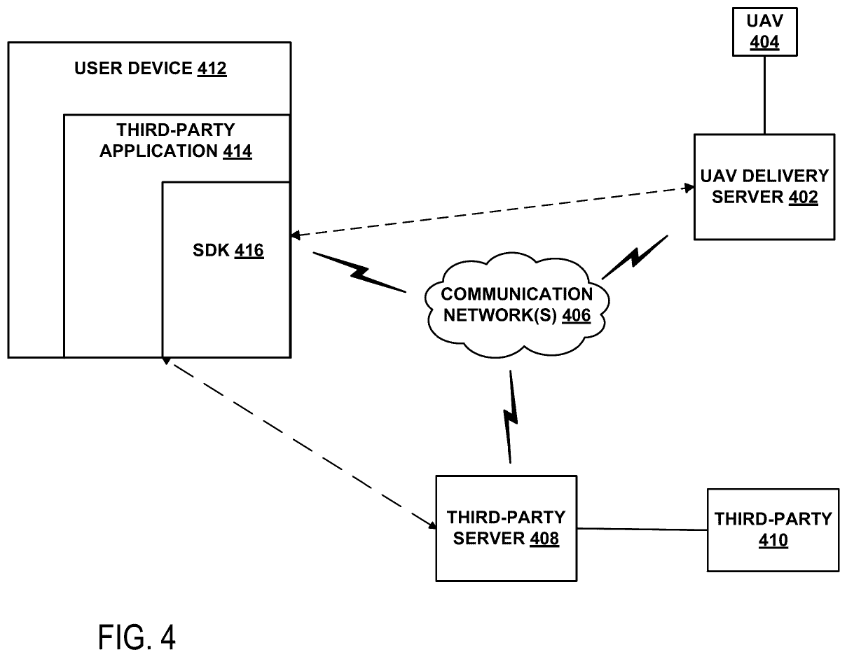

FIG. 4 is a simplified block diagram illustrating a UAV delivery communication system, in accordance with example embodiments. FIG. 4 illustrates a simplified block diagram of an example UAV delivery communication system. The system may include a user device 412 using a communication network 406 to communicate with a UAV delivery server 402 and a third-party server 408. A third-party application 414 and an SDK 416 within the third-party application 414 may be stored on the user device 412 and facilitate communication with the third-party server 408 and the UAV delivery server 402.

The third-party server 408 may be a remote server that facilitates communication and coordination between the third-party application 414, located on the user device 412, and the third-party 410. For example, the third-party server 408 may communicate and coordinate between the third-party application 414 and the third-party 410 when a user is interacting with the third-party application 414 to order an item that will be provided by the third-party 410.

The UAV delivery server 402 may be a remote server that facilitates the communication and coordination between the SDK 416, located on user device 412 within the third-party application 414, and a UAV 404. The UAV delivery server 402 may communicate between the UAV 404 and the SDK 416 to send/receive location data, status data, task data, tracking data, and/or any other type of data necessary to accomplish UAV delivery.

The SDK 416 may gather data received from multiple servers (e.g., the UAV delivery server 402 and the third-party server 408) and display the data on a single user interface within the third-party application 414 to provide the user with a concise and streamlined way to view information about item delivery.

The SDK 416 may use the communication network 406 to send data to and receive data from the UAV delivery server 402. A unique customer identifier associated with the user device 412 and/or user may be used to facilitate communication between the SDK 416 and the UAV delivery server 402. For example, the SDK 416 may send the unique customer identifier information to the UAV delivery server 402 and receive from the server previous delivery location data to display within the third-party application 414. The UAV delivery server 402 may use the delivery location received from the SDK 416 to determine whether UAV delivery is available for the requested location. The SDK 416 may then receive from the UAV delivery server 402, and display within the third-party application 414, an indication of UAV delivery availability. The SDK 416 may also send current location information of user device 412 to the UAV delivery server 402 and receive from the server graphical map data (e.g., environmental topography data) which the SDK may display on a user interface. The graphical map data may include an icon showing the user device location and/or UAV-accessible delivery locations from which the user may select. The SDK 416 may then send the selected UAV-accessible delivery location point to the UAV delivery server 402 which the UAV delivery server 402 may then send to the UAV 404. The SDK 416 may also send to the UAV delivery server 402 a message to initiate delivery of the payload (i.e. item(s) ordered) by the UAV 404. The UAV delivery server 402 may then relay the delivery initiation message and necessary information, such as delivery location data and/or third-party location data, to the UAV 404.

Before sending graphical map data and/or UAV-accessible delivery locations, the UAV delivery server 402 may use the delivery location received from the SDK 416 to determine whether UAV delivery is available for the requested location. The UAV delivery server 402 may also then determine if a UAV is available for fulfilling the delivery. The UAV delivery server 402 may determine the feasibility to deliver the payload to the delivery location. For example, the UAV delivery server 402 may determine the total energy required for the UAV to complete the delivery, weight data, weather data of the delivery route, delivery time required, or any other parameter necessary to determine feasibility for UAV delivery of the payload to the delivery location.

The SDK 416 may then receive from the UAV delivery server 402, and display within the third-party application 414, an indication confirming or denying UAV delivery availability. If UAV delivery availability is confirmed, the SDK 416 may continue with the UAV delivery process.

During a delivery sub-phase, the UAV 404 may send data, such as status information, location/tracking information (e.g., based on GNSS coordinates), and/or image data (e.g., from an image capture device on the UAV), to the UAV delivery server 402. The UAV delivery server 402 may then send the data received from the UAV 404 to the user device 412. The SDK 416 may take the UAV 404 data received from the UAV delivery server 402 and display it on the user interface within the third-party application 414. The SDK 416 may, therefore, enable the user to view UAV delivery information within the third-party application 414 in near real-time. This may allow the user to track the UAV 404 as it progresses through the delivery phases.

The SDK 416 may receive from the UAV delivery server 402 graphical map data along with the above mentioned tracking information for the UAV 404. The SDK 416 may then display on a user interface within the third-party application 414 the graphical map data and an icon representing the real-time location of the UAV 404 as it progresses through the delivery phases.

Once the item(s) have been ordered, a unique order identifier may be associated with the order. The order may, for example, pertain to the item(s) that ultimately become the payload transported by the UAV 404. The SDK 416 may use the order identifier to communicate with the third-party application 412 about the payload (e.g., by using item data). The SDK 416 and/or the third-party application 412 may be in communication with the third-party server 408 to send and receive item data. For example, the third-party server 408 may handle item order information, item status information during at least one pre-transport sub-phase, item payment information, etc. The third-party server 408 may facilitate the transmission of order data between the user device 412 and the third-party 410, via the unique order identifier associated with the item(s) ordered (i.e. payload). For example, the user may order an item on the third-party application 414 of user device 412; the SDK 416 or the third-party application 414 may send the order information to the third-party server 408 which may then send the order information to the third-party 410 to begin processing the order. Similarly, the third-party 410 may send order status information to the third-party server 408 which may then send it to the third-party application 414 or the SDK 416. The third-party 410 may provide information about an order status during a pre-delivery sub-phase, for example an indication that the order is being prepared or loaded into a UAV. The SDK 416 may take the received data from the third-party server 408 and display it on a user interface within the third-party application 414 on the user device 412.

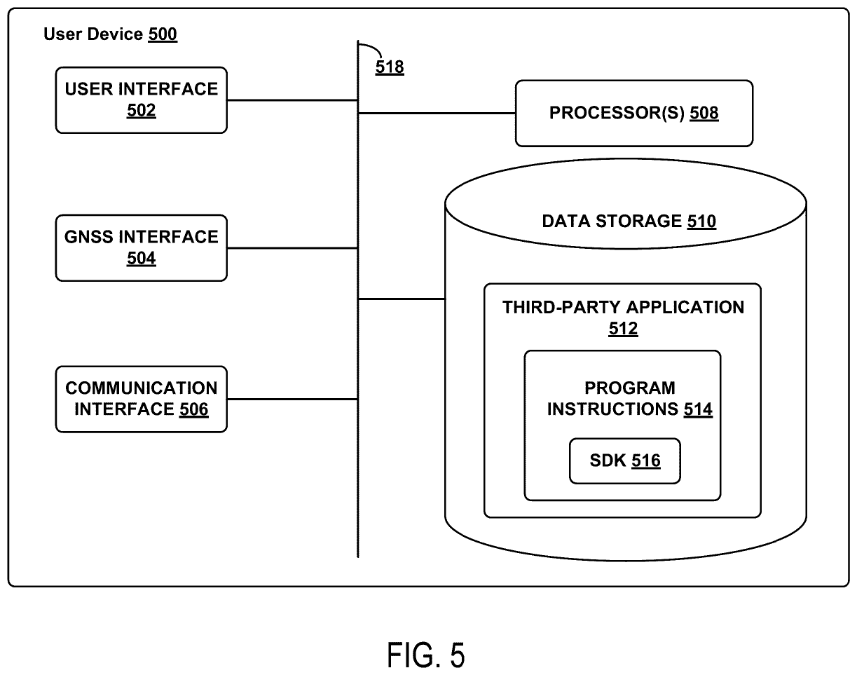

FIG. 5 is a simplified block diagram illustrating components of a user device, in accordance with example embodiments. The user device 500 may include a user interface 502, a GNSS interface 504, and a communication interface 506 in communication with one or more processor(s) 508 and data storage 510 via communication bus 518. A third-party application 512 may be stored within the data storage 510 on the user device 500. The third-party application 512 may include program instructions 514, which include an SDK 516 for UAV delivery. The processors 508 on the user device 500 may be used to execute the program instructions 514 and the SDK 516 located within the third-party application 512. The processors may facilitate the sending and receiving of data between the third-party application 512, the SDK 516, and remote servers which communicate with the programs stored on the user device 500.

As stated, the SDK 516 is located within the program instructions 514 of the third-party application 512 on the user device 500. The SDK 516 may be customizable by the third-party to suit the needs and requirements of the third-party application 512. Being fully integrated within the program instructions 514 of the third-party application 512 allows the user to view aspects of their order, including the UAV delivery process, within the third-party application 512 without having to navigate to another application or webpage. When the third-party application 512 is open on the user device 500 the processor(s) 508 may run the program instructions of the SDK 516 to display various screens on the user interface 502.

During operation, the third-party application 512 may be displayed on the user interface 502 of the user device 500. The user interface 502 may be used to select an item in the third-party application 512. When the user orders the item within the third-party application 512, the program instructions 514 may give the user the option to select UAV delivery for the item ordered. Selection of UAV delivery may prompt the SDK 516 within the program instructions 514 to execute instructions that include displaying a series of screens on user interface 502.

The global navigation satellite systems (GNSS) interface 504 may be configured to provide data that is typical of well-known GNSS, such as the GNSS coordinates of the user device 500. Such GNSS data may be utilized by the SDK 516 for various functions. GNSS data may be sent to the user device 500 by a service provider, and GNSS interface 504 may include position data, such as the location of the user device 500. The SDK 516 may communicate with the GNSS interface 504 to receive current location information (e.g., based on GNSS coordinates) of the user device 500. Other examples are also possible.

The user interface 502 may include visual means, audible means (e.g. speakers/stereos), touch means (e.g., vibrations), and/or any communication means currently employed or understood by those skilled in the art. The SDK 516 may alert the user to an order update by utilizing the user interface 502 to make a sound and/or a vibration. For example, when an order has been placed in the UAV and is in the UAV delivery phase, the user may receive from SDK 516 an indication that the UAV has commenced delivery of the payload. The SDK 516 may provide the indication via the user interface 502 in a visual, audible, and/or touch medium (such as vibrating the user device 500) to alert the user that the next phase in the order process has commenced. The SDK 516 may use some or all of the user device interfaces (502, 504, 506) in any or all phases and sub-phases of the item order delivery process.

Communication interface 506 may comprise various components to facilitate wireless communication between the user device 500 and other entities, such as between the user device device 500 and the UAV delivery server 402 and/or the third-party server 408. The communication interface 506 may include WiFi, BLUETOOTH, UWB, and cellular (e.g., 4G, 5G, 6G, etc.) capabilities that allow the user device 500 to communicate across a network(s), for example communication network(s) 406 with other devices. Each of these capabilities may be individually addressable and controllable.

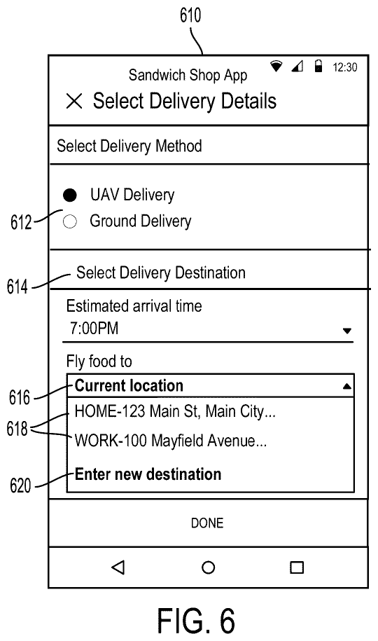

FIG. 6 is an illustrative screen of an SDK interface within a third-party application displayed on a user device, in accordance with example embodiments. When using a third-party application, for example to order an item from an item provider, a user might desire to have the item delivered at a location. There may be various forms of delivery available to the user, for example ground delivery and/or UAV delivery options.

FIG. 6 shows an example delivery detail screen 610 on a third-party application. Within the delivery detail screen 610 is the option for a user to select from multiple delivery methods 612, such as UAV delivery or ground delivery. In response to the user selection of the UAV delivery option, the SDK located within the third-party application is prompted to run various executable functions. For example, in response to receiving a selection within the third-party application to have an item delivered via UAV delivery, the SDK may display on the user device within the third-party application a first user interface portion that enables selection of a delivery point at a delivery location.

In some examples, the SDK may first obtain user consent for UAV delivery. More specifically, the SDK may display within the third party application a user interface portion of the software that is unmodifiable by the third-party in order to ensure secure communication with the user. The unmodifiable user interface portion may include a user confirmation for UAV delivery. The SDK may require receipt of the user confirmation before enabling entry of the user selection into the third-party application. For example, the SDK may display an unmodifiable activity within the third-party application, such as a “user agreement”, that the user must complete prior to continuing with the UAV delivery option. The user would be required to agree to the specific terms and conditions of the UAV delivery provider before proceeding with the UAV delivery process. The unmodifiable user interface portion may include a button, check box, and/or any other type of selection option for the user to press. The unmodifiable user interface portion may also display text, images, slides, and/or a video for the user to view. Sound may or may not be presented along with any of the visual features displayed in the unmodifiable user interface portion. For example, the unmodifiable user interface portion may include text displaying “terms and conditions” along with an option for an audible narration of the text, and/or the text may be accompanied by images illustrating various aspects contained within the text and/or narration. Preventing the third-party from modifying some user interface portions displayed by the SDK may create standardization and consistency in what is displayed to the user. This may also allow the UAV delivery provider to have more control over the user agreement.

As explained in the following paragraphs, the SDK may operate within the third-party application via the user interface to allow selection of a delivery location, then upon determining availability of UAV delivery for the delivery location, providing the user with delivery points from which to select.

With reference to FIG. 6, the SDK may display within the third-party application a user interface portion showing a plurality of delivery location options 614. As an illustrative example, the SDK may provide the user with the option to select delivery to a current location 616, previous delivery locations 618, or a new location 620.

For example, if a user selects the option to deliver to the current location 616, the SDK may then display within the third-party application a prompt for the user to authorize the SDK to access location data of the user device (e.g., based on GNSS coordinates of the user device). In response to receiving location data of the user device, the SDK may then send the location data to the UAV delivery server 402 and receive graphical map data (e.g., environmental topography data) from the UAV delivery server 402. The SDK may then display a graphical map within the user interface portion that may include an overhead view of a geographic area. For instance, the geographic area may be an area surrounding a location of the user device; the user device may be indicated by an icon displayed on the graphical map within the user interface portion.

The user may interact with the graphical map in order to select the target delivery location. For instance, the graphical map on the user interface portion may be displayed on a touchscreen of the user device such that the user may select a desired target delivery location by touching a corresponding location on the graphical map. In other examples, the user may click on the graphical map using a mouse or stylus.

In another example, the user may select to manually enter a new location 620, such as an address of the desired target delivery location. In response to selection of the new location 620, the SDK may display within the third-party application a user interface including an address field that the user may manually enter a new delivery location into. Once the user manually enters the delivery address, the SDK may provide the entered address to the UAV delivery server 402 to associate with a unique user identifier. When the user selects UAV delivery at a future date, the SDK may then display the prior manually entered address under the previous delivery locations 618 selection, described below.

In yet another example, the SDK may receive from a UAV delivery server, and display within the user interface of the third-party application, a list of previous delivery locations 618 associated with the user, that the user may select from. The list may identify the locations by an address and/or a name associated with each location. For instance, a user may specify that a particular address is associated with the user's home, and the list may identify that address by the name “Home.” Other examples are possible as well.

In some examples, the list of previous delivery locations 618 may be populated based on the user's order history and/or user preferences associated with an account of the user. The previous delivery locations 618 may be stored on the UAV delivery server 402 and include previous delivery addresses used across multiple third-party applications. The SDK may send to the UAV delivery server 402 the user identifier associated with the user device, then receive from the UAV delivery server 402 previous delivery location data associated with the user identifier. Based on the received data, the SDK may then display within the user interface a populated list of the previous delivery locations 618.

In this way, previous delivery locations 618 may be associated with a unique user identifier and are not constrained to the respective third-party application. Thus, the previous delivery locations 618 may include all previous UAV delivery locations of the user from all third-party applications in which UAV delivery has been requested. For example, the SDK may display a delivery location based on a previous user interaction with a different third-party application that uses the delivery SDK. The previous delivery locations 618 may include recently selected delivery locations, frequently selected delivery locations, and/or delivery locations identified as preferred by the user. Alternatively or additionally, the SDK may display previous delivery locations 618 within a threshold distance of the user (e.g., based on GNSS coordinates of the user device).

Once a delivery location has been selected, the SDK may determine, such as through communication with the UAV delivery server, whether UAV delivery is available in the geographic region. For example, the SDK may determine whether UAV delivery exists for the geographic region and/or whether there are any UAV-accessible delivery locations at or near the desired target delivery location. The SDK may communicate with the UAV delivery server to reference a database of UAV-accessible delivery locations. In communicating with the UAV delivery server, the SDK may send the selected delivery location to the UAV delivery server, then receive from the UAV delivery server an indication that UAV delivery for the selected address is available. The SDK may then display on a user interface within the third-party application an indication of the availability or unavailability of UAV delivery to the selected delivery location. In some examples, each of the UAV-accessible delivery locations may contain a plurality of UAV-accessible delivery point locations, while in other examples each UAV-accessible delivery location may correspond to a single UAV-accessible delivery point location.

Similarly, the SDK may reference the database of UAV-accessible sub-areas, on the UAV delivery server 402, to determine whether there are any UAV-accessible sub-areas at or near the desired target delivery location selected by the user. If there are no UAV-accessible sub-areas within a threshold distance of the selected delivery location, then the SDK may display within the user interface an indication as such and/or may display an indication of the nearest UAV-accessible sub-area. Alternatively, if there are one or more UAV-accessible sub-areas at or near the selected delivery location, then the SDK may display within the third-party application on the user device a more detailed graphical map for selecting one of the UAV-accessible sub-areas.

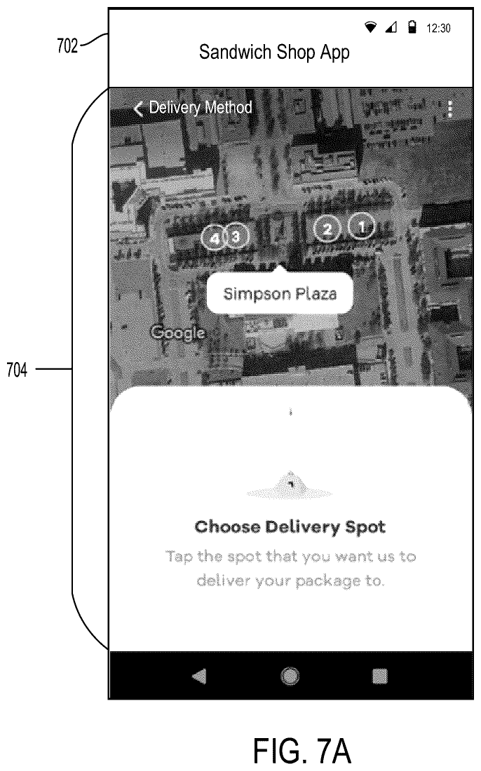

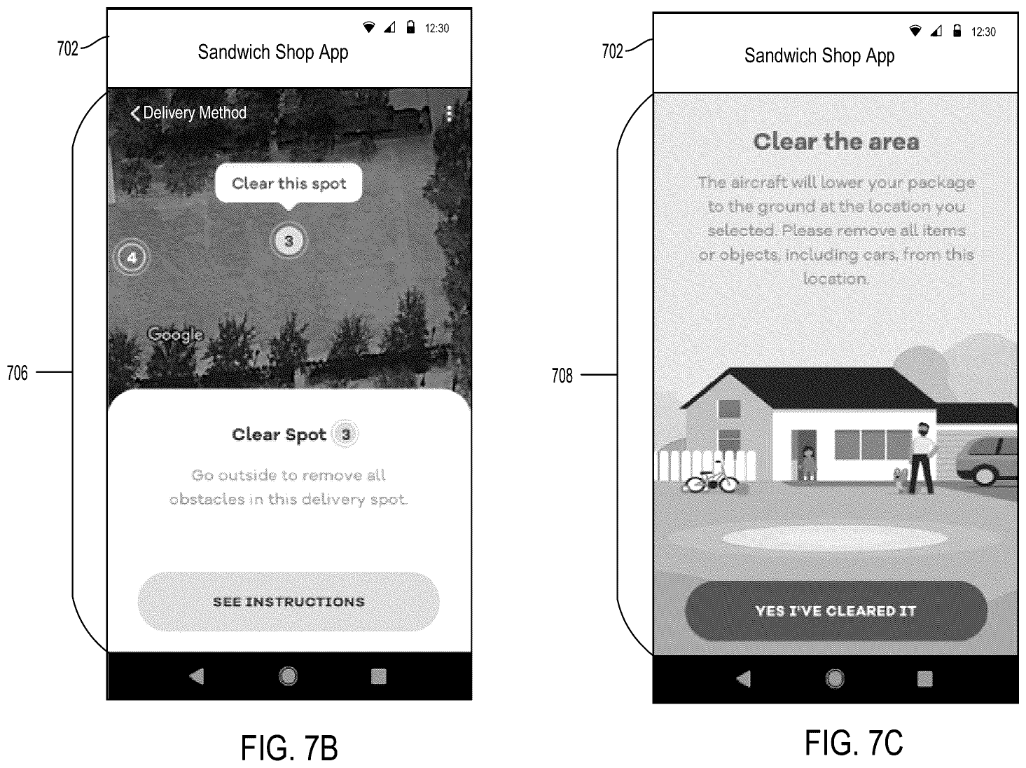

FIGS. 7A-7C are illustrative screens of a first UI portion of an SDK interface within a third-party application displayed on a user device, in accordance with example embodiments. FIG. 7A illustrates an example first UI portion 704 displayed by an SDK within a third-party application 702 on a user device, for selecting a UAV-accessible delivery point location based on the selected UAV-accessible delivery location received by the SDK. The first UI portion 704 may include a graphical map displaying an overhead view of a geographic area. The overhead view may be of a real estate property, such as a particular residence, business, park, municipal building, or some other location that may be selected via the SDK interface described in FIG. 6 (e.g., by interacting with the graphical map, selecting a previously used delivery address, or by inputting an address of the location).

In one example, a user may desire to have the item sent to their home and may select, via the user interface, their home address as the target delivery location. The user may then select, via the user interface provided by the SDK, the UAV-accessible delivery location, and the SDK may display the first UI portion 704 of an overhead view depicting one or more UAV-accessible delivery point locations at or near the user's home. For instance, as depicted in FIG. 7A, the UAV-accessible delivery point locations near the user's home may include numbers “1” through “4”, which correspond to the available UAV-accessible delivery point locations for the selected UAV-accessible delivery location. In other examples, there may be more or fewer UAV-accessible delivery point locations and/or more or fewer UAV-accessible delivery locations than those illustrated.

The SDK may communicate with the UAV delivery server 402 to retrieve data for display within the user interface of the third-party application. The SDK may also access map data and/or location data from the user device to display user device location within the user interface. In such an example, the user device location may be displayed within the first UI portion 704 along with the UAV-accessible delivery locations, and/or delivery point locations, so that the user may determine an approximate distance to each and/or the preferred option to select. The SDK may, therefore, receive data from multiple providers and display the data on a single user interface within the third-party application.

The first UI portion 704 may display the UAV-accessible delivery locations, and/or delivery point locations, in various manners. For instance, the first UI portion 704 may display one or more graphics associated with each respective UAV-accessible delivery location, and/or delivery point location. The graphics may indicate a boundary of each delivery location, and/or delivery point location. For instance, in examples where a UAV-accessible delivery point location comprises a circular area having an unobstructed vertical path to the sky, the graphical map may include a circle superimposed on the circular area. Other shapes or arrangements are possible as well.

Further, the first UI portion 704 may additionally or alternatively display a name or number of each UAV-accessible delivery point at the selected UAV-accessible delivery location. For instance, the first UI portion 704 may display the numbers 1 through 4 corresponding to each UAV-accessible delivery point location within the selected UAV-accessible delivery location. In examples where the first UI portion 704 displays different or additional delivery locations, the first UI portion 704 may also display corresponding names for each displayed delivery location (e.g. “Front Yard,” “Driveway,” “Porch,” etc.).

FIG. 7B is an illustrative screen of an SDK interface within a third-party application displayed on a user device, in accordance with example embodiments. Of the UAV-accessible delivery point locations displayed on the interface by the SDK within the third-party application, a user may select one (e.g., via touchscreen or mouse input) as a target delivery location. The SDK may provide within the third-party application 702 the first UI portion 706 showing a visual indication of the selected delivery location. For instance, as depicted in FIG. 7B, responsive to receiving a selection of the UAV-accessible delivery point location number “3”, the first UI portion 706 may display a graphic of the selected number in a particular color that is different from the unselected numbered UAV-accessible delivery point locations (e.g. “3” is highlighted while “4” remain un-highlighted). Further, the first UI portion 706 may additionally or alternatively display an icon, graphic, and/or words along with the selected UAV-accessible delivery point location. For example, FIG. 7B includes text above the selected UAV-accessible delivery point location informing the user to “Clear this spot”. The SDK may use other shapes, icons, graphics, text, and/or visual identifiers to display the user selection and/or provide further information to the user within the user interface.

The SDK may further display on the first UI portion 706 within the third-party application 702 text and/or a function for the user to select. The text and/or function may be an instruction the user should follow prior to receiving UAV-delivery at the selected UAV-accessible delivery point location. For example, the first UI portion 706 displays an instruction to clear spot 3, and further includes a selection button the user may click which prompts the SDK to display another user interface within the third-party application. FIG. 7C is an illustrative screen of an SDK interface within a third-party application displayed on a user device, in accordance with example embodiments.

FIG. 7C illustrates an example of the first UI portion 708 that may be displayed by the SDK within the third-party application 702 when the user selects the “See Instructions” function from the first UI portion 706 of FIG. 7B. In this example illustration, the first UI portion 708 shows a graphic, text, and a selection button. However, other embodiments may include a different graphic, text, and/or selection button, or not include some or all of these features. The first UI portion 708 might inform the user of how to clear an area in preparation for UAV delivery, and/or further include a selection button that the user may select to confirm the instructions have been completed. For instance, the first UI portion 708 includes a selection button the user may select that confirms “Yes I've Cleared It”. The user input of a selection may prompt the SDK to progress to subsequent steps in the UAV delivery process.

While the user interfaces shown in FIGS. 7A and 7B display an overhead view of the geographic area selected, other perspectives or views may be used. For example, the SDK may display within the third-party application a user interface showing an oblique view of the geographic area. The SDK displayed user interface may allow the user to toggle between different views or perspectives of the geographic area, and may include functional buttons to facilitate toggling, such as an overhead view button and a street view button. In other examples, the selected target delivery location may be a default location based on the user's order history (e.g., most recent or most frequent delivery location) user preferences associated with an account of the user (e.g., a location identified as preferred by the user).

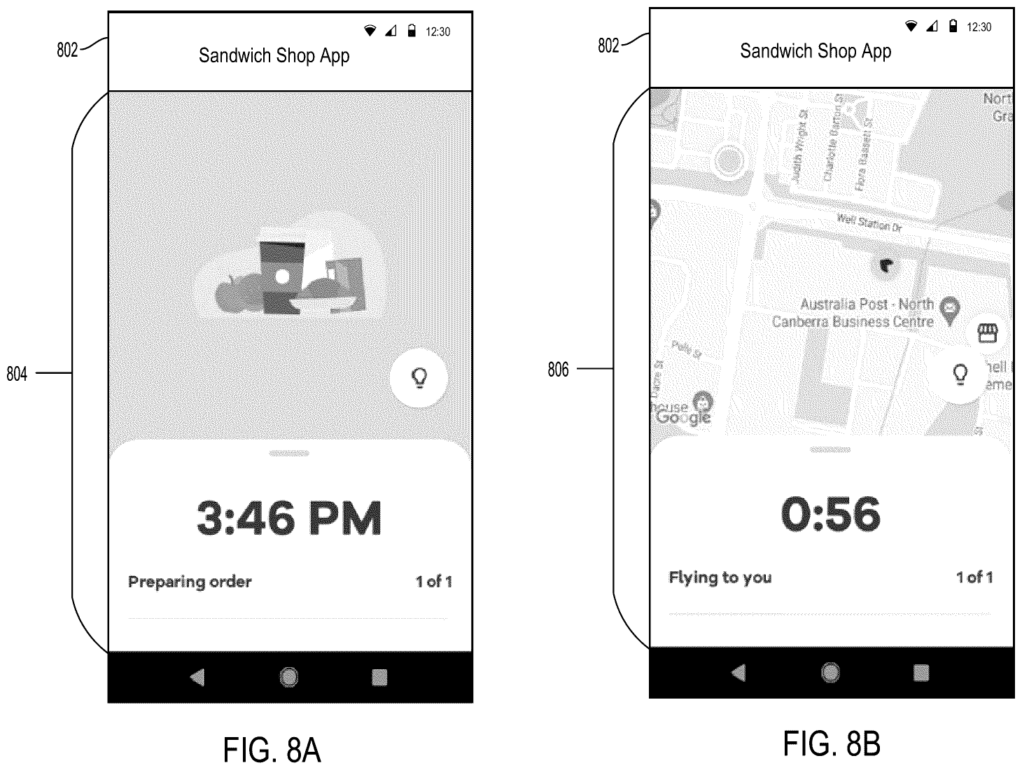

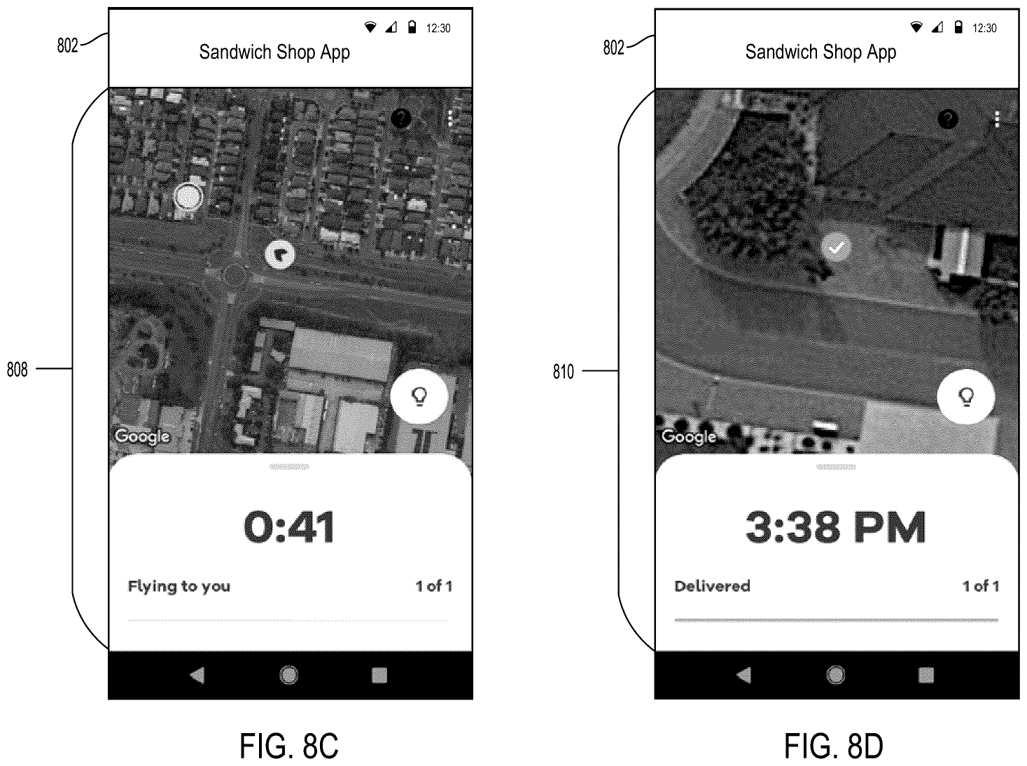

FIGS. 8A-8D are illustrative screens of a second UI portion of an SDK interface within a third-party application displayed on a user device, in accordance with example embodiments. It is to be understood that these are example user interface screens of what may be displayed, and that the display may be in another format or style, include more or less features, and more or less phases and/or sub-phases may be displayed on the user interface during UAV delivery. The spirit of the SDK is to provide the third-party with the ability to customize the user interface screens to suit its requirements and/or preferences while allowing the user to view relevant UAV delivery and payload information within the third-party application.

In accordance with example embodiments, the SDK may display within a third-party application, located on a user device, a user interface as the transport process progresses through its various phases and/or sub-phases. In some implementations, some or all updates to the user interface may be provided in real-time.

To facilitate such updates, a UAV delivery server may associate a particular UAV transport request with a client device and/or unique customer identifier, such as a customer number and/or an order number associated with the customer account. Using the aforementioned unique identifier, the UAV delivery server may detect when transitions between the various phases and/or sub-phases occur, and send delivery status update data to the SDK located within the third-party application on the user device. In response to receiving a delivery status update from the UAV delivery server, the SDK may then display order information within the second user interface portion within the third-party application. The SDK may receive delivery status update data every time a new sub-phase begins, or only when some (but not all) sub-phases begin. Further, the SDK may receive and display within the user interface of the third-party application an updated estimated timing information corresponding to the transport request (e.g., total transport time, estimated arrival time, etc.). Alternatively, the SDK might receive from the UAV delivery server updated transport timing information in some, but not all, status messages.

The screens illustrated in FIGS. 8A to 8D may be displayed by the SDK as a UAV delivery process progresses through its various phases and sub-phases. Each screen may include timing estimates determined in accordance with methodology described herein. Further, each screen shown in FIGS. 8A to 8D may include information and/or provide access to functionality related to a current phase and/or sub-phase of the fulfillment process for a UAV delivery request. The SDK may include APIs to allow the third-party applications to request and receive UAV delivery information, such as an estimated time of arrival (ETA). Additionally, the ETA shown in FIGS. 8A to 8D may be updated frequently by the SDK (and possibly displayed within the third-party application in real-time) during the course of the delivery. In so doing, the system that provides the ETA estimations may utilize data and consider factors as described herein, so as to provide a highly accurate ETA (which will typically become even more accurate as the delivery process progresses). Note that the SDK may display ETA in multiple forms on the user interface. For example, in FIG. 8A the SDK displays ETA as a time of day within the second user interface portion 804, whereas in FIG. 8B the SDK displays within the second user interface portion 806 the ETA as a countdown (time remaining) until delivery.

Further note that the example screens shown in FIGS. 8A to 8D characterize certain phases and sub-phases of the UAV delivery using terminology derived from commercial airline flights. By characterizing the phases and sub-phases of the UAV delivery in terms derived from commercial airline flights an example SDK within a third-party application may enhance the user-experience. In particular, since the UAV delivery process can differ significantly from traditional delivery processes, such characterization may help users better understand the status of their order by analogizing to a different but familiar context. It should be understood, however, that embodiments in which an application does not include such characterizations are also possible.

Referring now to FIG. 8A, FIG. 8A shows the second user interface portion 804 that may be displayed on the user device by the SDK within the third-party application 802 during an order processing sub-phase. The second user interface portion 804 thus provides an example of preparation status screen, which may be displayed by the SDK within the third-party application 802 on the user device. In the context of a UAV delivery application, the second user interface portion 804 may be displayed while requested items from the third-party are being prepared and/or packaged at the third-party location. The second user interface portion 804 may include an estimated ETA of the item at the delivery location, a status information, and/or order identification information. In the illustrated example, the SDK displays within the second user interface portion 804 an ETA based on local time at the delivery location and the status information “Preparing order”; however, other characterizations of status are also possible during the item preparation sub-phase. Additionally or alternatively the SDK may display within the third-party application 802 a user interface while waiting for a third-party to confirm receipt of a UAV delivery request for item(s) and/or while waiting for verification of a payment corresponding to a delivery request. The user interface may include any or all information discussed with respect to other user interface displays.

In a further aspect, the arrival-time estimate displayed within the second user interface portion 804 may be determined upon confirming the order (and before preparation of items begins). In particular, the arrival-time estimate may be determined based on the current time and an estimate of total transport time. For instance, arrival-time estimate may be based on a total transport time that is determined based on a combination of at least (a) a preparation-to-loading time estimate for the one or more selected items, and (b) a flight time estimate for transport of the one or more items to the target location by a UAV. Thus, the arrival-time estimate may account for the pre-flight phase and the flight phase. As such, the preparation-to-loading time used to determine estimated timing of the pre-flight phase, and ultimately the arrival time estimate, may be determined based on timing estimates for and/or current status of the item-preparation phase.

The SDK may receive first delivery status information for the payload from the third-party server 408, and the SDK may receive second delivery status information for the payload from the UAV delivery server 402. The SDK may then display at the user device within the third-party application an estimated time of arrival for the payload based on the first delivery status information and the second delivery status information. For example, the SDK may receive UAV delivery estimated flight time information from the UAV delivery server 402 and estimated item preparation status information (e.g., estimated preparation time) from the third-party server 408; in such an example the SDK may combine the information received to display a single arrival time estimate within the second user interface portion 804. In some examples, the SDK may receive the first delivery status information for the payload from the third-party application 414.

Referring now to FIG. 8B, FIG. 8B shows an SDK displayed second user interface portion 806 from within the example third-party application 802 located on the user device. The second user interface portion 806 may be displayed by the SDK within the third-party application during transit of an item undergoing a UAV delivery sub-phase. The second user interface portion 806 may include status information (e.g., “Flying to you”), an arrival time estimate of the UAV at the selected delivery location (e.g., a countdown clock of “0:56” remaining until delivery), and/or order identification information.

The SDK may further display within the second user interface portion 806 a graphical map view showing the delivery location selected and/or the current location of the UAV as it progresses along the delivery process. For example, the SDK may place an icon on the map showing the delivery location selected by the user, and/or use the current GNSS location of the user device to overlay an icon on the map shown in the second user interface portion 806. The SDK may further receive GNSS data of the UAV out for delivery from the UAV delivery server. The SDK may display the received current position of the UAV on the second user interface portion 806, this may be indicated by an icon symbolizing the current UAV position and may be displayed along with the selected delivery location icon.

Further yet, in some examples the SDK may receive from the third-party application, the user's order information and display this information within the user interface. To facilitate this, the SDK may use a unique order identification number and/or unique customer number to locate order information. For example, the SDK may display within the user interface the current position of the UAV on a map as it flies to the delivery location along with information of the items ordered. As a more concrete example, the SDK may display on the user interface that the UAV is currently flying over the adjacent neighborhood (illustrated by an icon representing the UAV on the map) along with text that shows the items on the UAV are a sandwich, fries, and beverage. In this way, the SDK may access data stored on multiple servers and/or stored by multiple entities and display it on a single user interface within the third-party application.

While in FIG. 8B the second user interface portion 806 displayed by the SDK shows a graphical map representation of the UAV delivery process, other representations are possible. For example, FIG. 8C illustrates an SDK displayed second user interface portion 808 from within the third-party application 802 showing a satellite map view of the process outline with respect to FIG. 8B. The SDK may allow the user to toggle between different map views within the user interface, and/or may allow the third-party to select a preferred presentation style of the SDK user interface within the respective third-party application.

Additionally, the SDK may allow for adjustment of features displayed within the user interface. For example, the map feature may be adjustable to show a closer or farther out view; the text style, color, display location, language, etc. may be adjusted to suit user and/or third party preferences. As previously stated, order information may be displayed within the user interface; however, order information may also be set to be accessible within a tab located on the user interface so that a user may open another user interface portion provided by the SDK to view order information, then close the user interface portion to return to the map. Other permutations and combinations of customizability are also possible.

FIG. 8D shows another SDK displayed second user interface portion 810 from within a third-party application 802 on the user device. In particular, the second user interface portion 810 may be displayed by the SDK when the item has been delivered by the UAV, and the order is ready to be picked up by the user. For example, the second user interface portion 810 may be displayed when requested items have been lowered to the ground via a tether, and released from the tether (or the tether is released from the UAV).

Note that in some embodiments the SDK may display another sub-phase within the user interface prior to delivery of the item. For example, the SDK may display an approach sub-phase or an in-progress delivery sub-phase prior to displaying the item as delivered. The distinction between the approach sub-phase, in-progress delivery sub-phase, and delivery completion may be particularly beneficial to the user-experience in the context of tethered UAV delivery. More specifically, tethered delivery can involve finding the appropriate area within the delivery location and/or the appropriate time (e.g., avoiding winds) to lower the items. As such, tethered delivery can take longer, and is a more significant part of the larger delivery process than, e.g., a delivery driver walking an item to a purchaser's front door. Further, for safety reasons, it may be desirable for the user to be clear of the delivery area until the items are on the ground and have been released from the tether (or the tether is released from the UAV), and possibly until the UAV has flown a certain distance from the delivery area. At the same time, users typically appreciate having access to their items as quickly as possible. By having the SDK provide distinct graphical indications within the user interface on the third-party application for arrival, in-progress tethered delivery, and delivered (completion of a tethered delivery), the user is better informed as to the status of their item delivery, such that they can safely pick up their item at the earliest time possible.

In some examples, such as the example shown in FIG. 8D, the SDK may provide, within the second user interface portion 810, an image of the delivery location that the item was delivered to. The SDK may receive the image data from the UAV delivery server of the location the UAV delivered to.

There may be instances where multiple UAVs are utilized to fulfill delivery of a single order request. In such instances, the SDK may provide information related to the multiple UAVs fulfilling the same order delivery request.

For example, the SDK may display a user interface, within a third-party application on the user device, showing the locations of all UAVs fulfilling the same order on a map feature, such as the map features discussed in FIGS. 8B-8D. Alternatively, the SDK may show within the user interface only the location of one of the UAVs that is fulfilling a given order. As an example, the user interface displayed by the SDK may only show the locations of the UAV that is the furthest from the selected delivery location and/or that is scheduled to be the last UAV to lower its items to the ground in the delivery area. By only indicating the last UAV in the group, the SDK may provide an indication of the expected time that the entire order will be ready for retrieval from the delivery area (since safety considerations will likely prevent the user from retrieving any items before all UAVs have lowered their items to the ground). As stated with other examples, the SDK may communicate with a UAV delivery server and/or third-party application and/or third-party server to retrieve information about the order delivery when multiple UAVs are required.

In some examples the SDK may adjust the presentation of the first user interface portion and/or the second user interface portion based on the screen allocation provided by the third-party application. The third-party application may set the amount of screen space it wishes to allocate to the SDK for display of either the first and/or second user interface portion. For example, the third-party application may configure the SDK to display either the first and/or second user interface portion in 25 percent, 50 percent, 75 percent, or 100 percent of the user interface presented to the user so that the third-party application may optionally present other information to the user in a remaining portion of the user interface. The SDK may adjust the presentation of the first and/or second UI portion to accommodate depending on the amount of screen space allocated by the third-party application. For instance, if more space is allocated, a full graphical map may be shown by the SDK. On the other hand, if less space is allocated, a reduced map showing only symbolic representations of objects in an area may be shown instead.

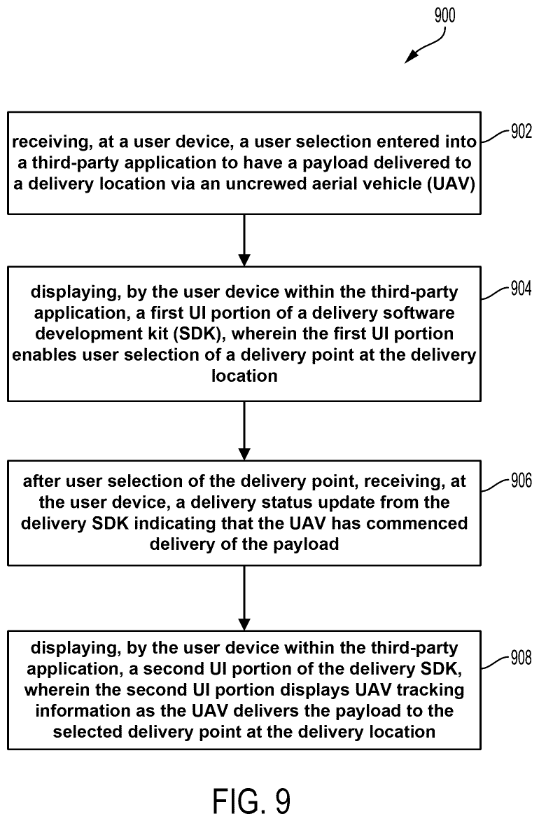

FIG. 9 is a simplified block diagram of a method, in accordance with example embodiments. Blocks 902, 904, 906, and 908 may collectively be referred to as method 900. In some examples, method 900 may be carried out by a user device having one or more processors, executing program instructions stored in a computer readable medium. Execution of method 900 may involve an SDK, such as the SDK illustrated and described with respect to FIGS. 4-8. Other SDKs may also be used in the performance of method 900. Execution of method 900 may also involve a UAV, such as the UAV illustrated and described with respect to FIGS. 1-2. Other UAVs may also be used in the performance of method 900. In further examples, some or all of the blocks of method 900 may be performed by a remote processor separate from the user device.

Those skilled in the art will understand that the block diagram of FIG. 9 illustrates functionality and operation of certain implementations of the present disclosure. In this regard, each block of the block diagram may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 902, method 900 includes receiving, at a user device, a user selection entered into a third-party application to have a payload delivered to a delivery location via a UAV. The third-party application may display UAV delivery among multiple types of delivery options, such as ground delivery and UAV delivery. Presentation of the delivery options for selection may include a drop down menu or radial buttons, for example, or any typical manner employed by those skilled in the art.

At block 904, method 900 includes displaying, by the user device within the third-party application, a first user interface (UI) portion of an SDK, where the first UI portion enables user selection of a delivery point at the delivery location. Prior to displaying delivery points for selection, the SDK may send to the UAV delivery server a user identifier associated with the user device, which the UAV delivery server may use to reference delivery locations associated with the user identifier. The SDK may then receive from the UAV delivery server the delivery location(s) associated with the user identifier, and populate the user interface with the delivery location data.

At block 906, the method 900 includes after selection of the delivery point, receiving, at the user device, a delivery status update from the delivery SDK indicating that the UAV has commenced delivery of the payload.

At block 908, the method 900 includes displaying, by the user device within the third-party application, a second UI portion of the delivery SDK, where the second UI portion displays UAV tracking information as the UAV delivers the payload to the selected delivery point at the delivery location.

In some examples the delivery location may be manually entered into the first UI portion in the third-party application displayed by the user device.

The method 900 may also include sending, from the user device to a UAV delivery server, a user identifier associated with the user device; receiving, from the UAV delivery server, the delivery location, where the delivery location is associated with the user identifier; and populating a field of the first UI portion with the delivery location.

In some examples the method 900 may additionally include after populating the field of the first UI portion with the delivery location, receiving a different delivery location manually entered into the first UI portion in the third-party application displayed by the user device; and providing the different delivery location to the UAV delivery server for association with the user identifier. In some examples the delivery location associated with the unique identifier may be based on previous user interaction with a different third-party application using the delivery SDK.

In further examples the method 900 may additionally include prompting, by the user device, for authorization to share a location of the user device via the first UI portion; after receiving authorization, sending, from the user device to a UAV delivery server, the location of the user device; and receiving, from the UAV delivery server, the delivery location, where the delivery location is associated with the location of the user device.

In some examples, the payload of method 900 may be associated with an order identifier, where the third-party application communicates with the delivery SDK about the payload using the order identifier.

After user selection of the delivery point the method 900 may also include receiving, at the user device from a UAV delivery server via the delivery SDK, UAV delivery information; receiving, at the user device from a third-party server, payload information; and displaying, the user device, a user confirmation screen comprising at least a portion of the UAV delivery information and at least a portion of the payload information.

The method 900 may further include before displaying the first UI portion, confirming, by the user device communicating with a UAV delivery server via the delivery SDK, UAV availability to deliver to the delivery location.

The method 900 may also include after the user selection of the delivery point, confirming, by the user device communicating with a UAV delivery server via the delivery SDK, UAV feasibility to deliver the payload to the delivery point.

In some examples the first UI portion of the delivery SDK may be displayed to illustrate environmental topography data for the delivery location, where the environmental topography data may be received at the user device from a UAV delivery server via the delivery SDK.

In some examples the delivery SDK may adjust the presentation of the first UI portion or the second UI portion based on screen allocation provided by the third-party application.

Prior to receiving the user selection, the method 900 may additionally include receiving, at the user device via an unmodifiable UI portion of the software SDK displayed within the third-party application, user confirmation for UAV delivery; and after receiving the user confirmation for UAV delivery, enabling entry of the user selection into the third-party application.

After user selection of the delivery point, the method 900 may include sending, by the user device to a UAV delivery server via the delivery SDK, a message to initiate delivery of the payload by the UAV.

The method 900 may further include displaying, by the user device within the first UI portion, a prompt to clear an area surrounding the delivery point at the delivery location; and receiving by the user device via the first UI portion, a confirmation that the area surrounding the delivery point has been cleared before UAV delivery is initiated.

The method 900 may also include receiving, at the user device from a UAV delivery server via the delivery SDK, the UAV tracking information.

In some examples the second UI portion of the delivery SDK may illustrate map data including a real-time location of the UAV, where the map data may be received at the user device from a UAV delivery server via the delivery SDK.

The method 900 may additionally include receiving, at the user device from a UAV delivery server via the delivery SDK, a sequence of delivery states for the payload, where an indication of one or more of the delivery states is displayed within the second UI portion.

The method 900 may also include receiving, at the user device from a third-party server, first delivery status information for the payload; receiving, at the user device from a UAV delivery server via the delivery SDK, second delivery status information for the payload; and displaying, at the user device within the third-party application, an estimated time of arrival for the payload based on the first delivery status information and the second delivery status information.

### VI. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above-detailed description describes various features and functions of the disclosed systems, devices, and methods with reference to the accompanying figures. In the figures, similar symbols typically identify similar components unless context dictates otherwise. The example embodiments described herein and in the figures are not meant to be limiting. Other embodiments can be utilized, and other changes can be made without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer-readable medium such as a storage device including a disk or hard drive or other storage medium.

The computer-readable medium may also include non-transitory computer-readable media such as computer-readable media that stores data for short periods of time like register memory, processor cache, and random access memory (RAM). The computer-readable media may also include non-transitory computer-readable media that stores program code or data for longer periods of time, such as secondary or persistent long-term storage, like read-only memory (ROM), optical or magnetic disks, compact-disc read-only memory (CD-ROM), for example. The computer-readable media may also be any other volatile or non-volatile storage systems. A computer-readable medium may be considered a computer-readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
receiving, at a user device, a user selection entered into a third-party application to have a payload delivered to a delivery location via an uncrewed aerial vehicle (UAV);
displaying, by the user device within the third-party application, a first UI portion of a delivery software development kit (SDK), wherein the first UI portion enables user selection of a delivery point at the delivery location;
after user selection of the delivery point, receiving, at the user device, a delivery status update from the delivery SDK indicating that the UAV has commenced delivery of the payload; and
displaying, by the user device within the third-party application, a second UI portion of the delivery SDK, wherein the second UI portion displays UAV tracking information as the UAV delivers the payload to the selected delivery point at the delivery location.

2. The method of claim 1, wherein the delivery location is manually entered into the first UI portion in the third-party application displayed by the user device.

3. The method of claim 1, further comprising:
sending, from the user device to a UAV delivery server, a user identifier associated with the user device;
receiving, from the UAV delivery server, the delivery location, wherein the delivery location is associated with the user identifier; and
populating a field of the first UI portion with the delivery location.

4. The method of claim 3, further comprising:
after populating the field of the first UI portion with the delivery location, receiving a different delivery location manually entered into the first UI portion in the third-party application displayed by the user device; and
providing the different delivery location to the UAV delivery server for association with the user identifier.

5. The method of claim 3, wherein the delivery location associated with the user identifier is based on previous user interaction with a different third-party application using the delivery SDK.

6. The method of claim 1, further comprising:
prompting, by the user device, for authorization to share a location of the user device via the first UI portion;
after receiving authorization, sending, from the user device to a UAV delivery server, the location of the user device; and
receiving, from the UAV delivery server, the delivery location, wherein the delivery location is associated with the location of the user device.

7. The method of claim 1, wherein the payload is associated with an order identifier, wherein the third-party application communicates with the delivery SDK about the payload using the order identifier.

8. The method of claim 1, further comprising after user selection of the delivery point:
receiving, at the user device from a UAV delivery server via the delivery SDK, UAV delivery information;
receiving, at the user device from a third-party server, payload information; and
displaying, the user device, a user confirmation screen comprising at least a portion of the UAV delivery information and at least a portion of the payload information.

9. The method of claim 1, further comprising before displaying the first UI portion, confirming, by the user device communicating with a UAV delivery server via the delivery SDK, UAV availability to deliver to the delivery location.

10. The method of claim 1, further comprising after the user selection of the delivery point, confirming, by the user device communicating with a UAV delivery server via the delivery SDK, UAV feasibility to deliver the payload to the delivery point.

11. The method of claim 1, wherein the first UI portion of the delivery SDK is displayed to illustrate environmental topography data for the delivery location, wherein the environmental topography data is received at the user device from a UAV delivery server via the delivery SDK.

12. The method of claim 1, wherein the delivery SDK adjusts presentation of the first UI portion or the second UI portion based on screen allocation provided by the third-party application.

13. The method of claim 1, further comprising prior to receiving the user selection:
receiving, at the user device via an unmodifiable UI portion of the software SDK displayed within the third-party application, user confirmation for UAV delivery; and
after receiving the user confirmation for UAV delivery, enabling entry of the user selection into the third-party application.

14. The method of claim 1, further comprising after user selection of the delivery point, sending, by the user device to a UAV delivery server via the delivery SDK, a message to initiate delivery of the payload by the UAV.

15. The method of claim 1, further comprising:
displaying, by the user device within the first UI portion, a prompt to clear an area surrounding the delivery point at the delivery location; and
receiving by the user device via the first UI portion, a confirmation that the area surrounding the delivery point has been cleared before UAV delivery is initiated.

16. The method of claim 1, further comprising receiving, at the user device from a UAV delivery server via the delivery SDK, the UAV tracking information.

17. The method of claim 1, wherein the second UI portion of the delivery SDK illustrates map data including a real-time location of the UAV, wherein the map data received at the user device from a UAV delivery server via the delivery SDK.

18. The method of claim 1, further comprising receiving, at the user device from a UAV delivery server via the delivery SDK, a sequence of delivery states for the payload, wherein an indication of one or more of the delivery states is displayed within the second UI portion.

19. The method of claim 1, further comprising:
receiving, at the user device from a third-party server, first delivery status information for the payload;
receiving, at the user device from a UAV delivery server via the delivery SDK, second delivery status information for the payload; and
displaying, at the user device within the third-party application, an estimated time of arrival for the payload based on the first delivery status information and the second delivery status information.

20. A user device comprising:
one or more processors; and
a non-transitory computer readable medium comprising program instructions executable by the one or more processors to perform operations comprising:
receiving a user selection entered into a third-party application to have a payload delivered to a delivery location via an uncrewed aerial vehicle (UAV);
displaying, within the third-party application, a first UI portion of a delivery software development kit (SDK), wherein the first UI portion enables user selection of a delivery point at the delivery location;
after user selection of the delivery point, receiving a delivery status update from the delivery SDK indicating that the UAV has commenced delivery of the payload; and
displaying, within the third-party application, a second UI portion of the delivery SDK, wherein the second UI portion displays UAV tracking information as the UAV delivers the payload to the selected delivery point at the delivery location.

21. A non-transitory computer readable medium comprising program instructions executable by one or more processors to perform operations comprising:
receiving, at a user device, a user selection entered into a third-party application to have a payload delivered to a delivery location via an uncrewed aerial vehicle (UAV);
displaying, by the user device within the third-party application, a first UI portion of a delivery software development kit (SDK), wherein the first UI portion enables user selection of a delivery point at the delivery location;
after user selection of the delivery point, receiving, at the user device, a delivery status update from the delivery SDK indicating that the UAV has commenced delivery of the payload; and
displaying, by the user device within the third-party application, a second UI portion of the delivery SDK, wherein the second UI portion displays UAV tracking information as the UAV delivers the payload to the selected delivery point at the delivery location.
